(19) United States
(12) Patent Application Publication
(10) Pub. No.: US 2002/0011203 A1
(43) Pub. Date: Jan. 31, 2002

(54) Multi wafer introduction/single wafer conveyor mode processing system and method of processing wafers using the same

(75) Inventor: Steven Kim, Harrington Park, NJ (US)

Correspondence Address: MORGAN, LEWIS & BOCKIUS, 1800 M STREET NW, WASHINGTON, DC, 20036-5869, US

(73) Assignee: SKION CORPORATION

(21) Appl. No.: 09/749,456

(22) Filed: Dec. 28, 2000

Related U.S. Application Data
(60) Provisional application No. 60/174,158, filed on Jan. 3, 2000.

(51) Int. Cl. B05C 5/00

(52) U.S. Cl. 118/305

(57) ABSTRACT

High throughput and low capital equipment costs can be achieved by increasing process rates was well as increasing the number of deposition clusters in a current cluster system. Increases in throughput can be achieved by multi-wafer entry mode wherein a stack of multiple wafers is introduced to a processing chamber via a transfer chamber. Thus, no gate valves are required for each deposition stage and a conveyor transports the individual wafer from deposition stage to deposition stage thereby increasing throughput. The elimination of gate valves, pumps, control electronics and other miscellaneous parts will also reduce the cost of the equipment.

This application claims the benefit of a provisional application, entitled “Multi Wafer Introduction/Single Wafer Conveyor Mode Processing System,” which was filed on Jan. 3, 2000, and assigned Provisional Application Number 60/174,158,which is hereby incorporated by reference.

### BACKGROUND OF THE INVENTION

1. Field of the Invention

The present invention relates to a wafer processing system, and more particularly, to a multi wafer introduction/single wafer conveyor mode processing system and a method of processing wafers using the same. Although the present invention is suitable for a wide scope of applications, it is particularly suitable for a low cost system of processing multiple wafers using a single wafer conveyor mode system having high throughput.

2. Description of the Related Art

High throughput and low capital cost are key requirements for current advanced manufacturing semiconductor deposition equipment. High throughput can be achieved by increasing process rates as well as providing multitudes of deposition clusters in a current cluster mode system. Maximum throughput is now limited by required mechanical operation timing of valves. As a result, throughput of single entry mode cluster tools has reached a limit. A further increase of throughput can be achieved by providing a multi-wafer entry facility into the processing area.

Currently, most semiconductor processing systems use a single wafer/multiple chamber system for processing semiconductor wafers. In such single wafer/multiple processing systems, a robot arm is used to transfer a wafer from a loading chamber to a processing chamber or from a processing chamber to a loading chamber. Throughput of the system is dependent upon processing time and loading time, which is in turn determined by robot arm speed, pump-down time, gas feeding time, and loading time. While processing time can be improved by provision of a multiple number of processing chambers, the loading time is constrained by the loading time limit of the single wafer loading mechanism.

### SUMMARY OF THE INVENTION

Accordingly, the present invention is directed to a multi-wafer introduction/single wafer conveyor mode processing system and a method of processing wafers using the same that substantially obviates one or more problems due to limitations and disadvantages of the related art.

Another object of the present invention is to provide for a system and method for introducing wafers from an introduction chamber to a processing chamber system, which has a maximum throughput limited by only a speed of the robot arm within the system.

Additional features and advantages of the present invention will be set forth in the description which follows and in part will be apparent from the description, or may be learned by the practice of the invention. Other advantages of the invention will be realized and attained by the structure and method particularly pointed out in the written description and claims hereof as well as the appended drawings.

To achieve these and other advantages and in accordance with the purpose of the present invention, as embodied and broadly described, a method for introducing a stack of multiple wafers to a processing chamber system according to the present invention includes the steps of loading a first stack including multiple wafers onto a stage, delivering the first stack to a first transfer chamber, wherein a pressure of the first transfer chamber is equilibrated with a pressure of the processing chamber system, introducing the first stack to a loading chamber of the processing chamber system, transferring each individual wafer of said first stack to a circular conveyor track, wherein a second stack including multiple wafers is introduced to a second transfer chamber simultaneously as the transferring step is performed.

In another aspect of the present invention, a wafer introduction system includes an introduction chamber connected to a transfer chamber, a loading chamber connected to the transfer chamber, at least one processing chamber system connected to the loading chamber, and at least one circular, continuously moving conveyor track disposed within the processing chamber system.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute part of this application, illustrate embodiments of the invention and together with the description serve to explain the principle of the invention.

In the drawings:

FIG. 1 is a plan view of a multi-wafer introduction/single wafer conveyor mode processing system according to the present invention;

FIG. 2 is a schematic view of introduction, transfer and processing chambers including an elevating stage of the present invention;

FIG. 3 is a partial view of a processing chamber including an elevating stage and conveyor track of the present invention; and,

FIG. 4 is a partial view of adjoining deposition stages including shield plates of the present invention.

### DETAILED DESCRIPTION OF THE PREFERRED EMBODIMENTS

Reference will now be made in detail to the embodiments of the present invention, examples of which are illustrated in the accompanying drawings.

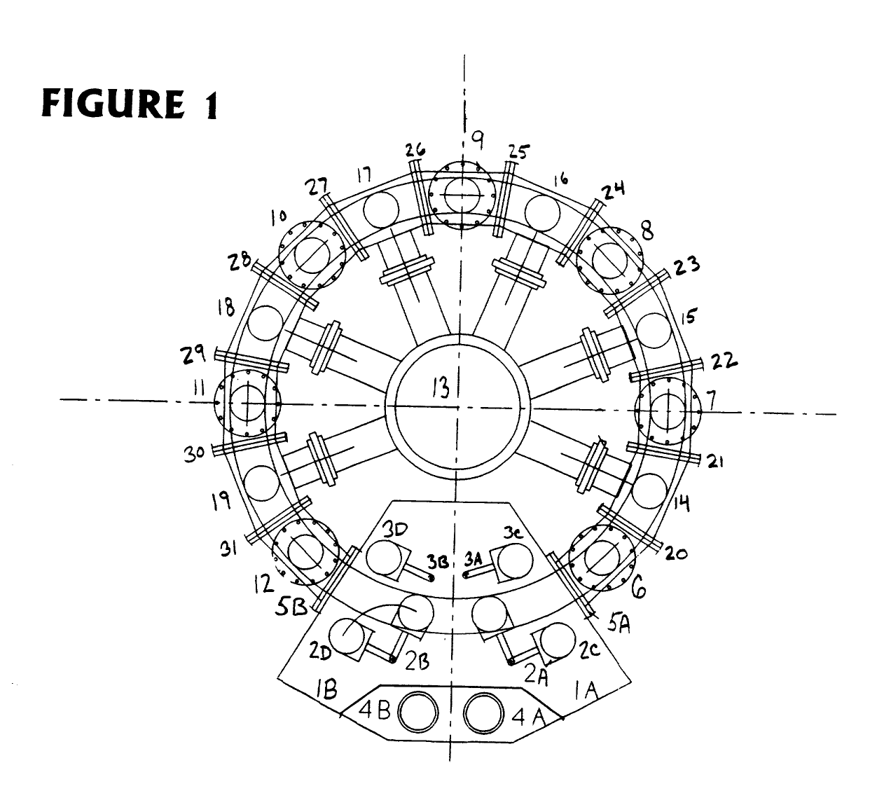

As illustrated in FIG. 1, a multi-wafer introduction/single wafer conveyor mode processing system according to the present invention is shown.

In the processing system of the present invention, loading portal (4A) and unloading portal (4B) are respectfully associated with loading (1A) and unloading (1B) chambers which are directly attached to adjacent deposition stages (6-12) of a processing chamber via respective flange connections (5A,5B). The adjacent deposition stages (6-12) of the processing chamber form a continuous doughnut-shaped processing chamber with a centrally located vacuum pump (13). The vacuum pump (13) is connected to intermediate chamber portions (14-19). Each individual deposition stage (6-12) of the processing chamber is connected to an adjoining deposition stage via the intermediate chamber portions (14-19) where throttle valves (15) are disposed between each deposition stage and each intermediate chamber portion without the use of vacuum-tight valves. By not using vacuum-tight valves between the individual deposition stages, higher throughput of the processing system can be achieved in the present invention. Each deposition stage of the processing chamber may include two deposition heads - one for an upper wafer surface and one for a lower wafer surface. The processing chamber may include both two-headed deposition stages and single-headed deposition stages in differing configurations and combinations dependent upon the desired throughput of the processing system. Within the loading chamber (1A) there are robot arms (2A,3A) respectfully associated with entry gateways (2C,3C) of the loading chamber and within the unloading chamber (1B) there are robot arms (2B,3B) respectfully associated with exit gateways (2D,3D). The total number of loading chambers, unloading chambers, robot arms, entry doors, exit doors, deposition stages, intermediate chamber portions and throttle valves are dependent upon the desired throughput of the processing system.

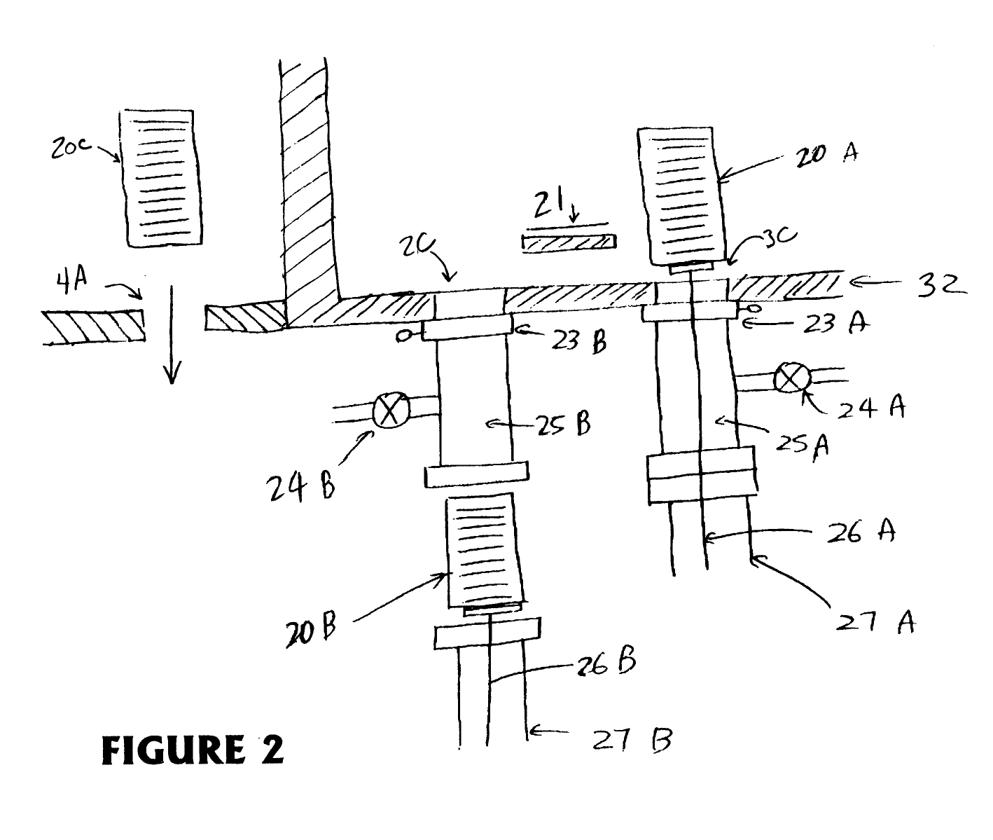

As shown in FIG. 2, exterior to the processing chamber walls (32) are a loading portal (4A), linear motion introduction chambers (27A,27B), transfer chambers (25A,25B) and stack introduction gate valves (23A,23B). After a stack of multiple wafers (20C) is transported through the loading portal (4A), the stack of multiple wafers (20C) is transferred into a cassette cage of a stage having a linear motion feeding mechanism for introduction into the loading chamber. The loading process in the loading chamber (1A)is described as follows. Initially, a first stack of multiple wafers is transferred into a first cassette cage (20A) on a stage of a first linear motion feeding mechanism (26A) of the first linear motion introduction chamber (27A). The first cassette cage (20A) is then delivered to a first transfer chamber (25A) and a flange of the first linear motion introduction chamber (27A) is mated to a flange of the first transfer chamber (25A), thereby isolating the pressure of the first transfer chamber (25A) from the ambient pressure.

Alternatively, after a first cassette cage (20A) is loaded onto a stage of a first linear motion feeding mechanism (26A) of the first linear motion introduction chamber (27A), a flange of the first linear motion introduction chamber (27A) is mated to a flange of the first transfer chamber (25A) and the first cassette cage (20A) is delivered to the first transfer chamber (25A). Alternatively, after a first cassette cage (20A) is loaded onto a stage of the first linear motion feeding mechanism (26A) of the first linear motion introduction chamber (27A), the flange of the first linear motion introduction chamber (27A) is mated to a flange of the first transfer chamber (25A) while simultaneously the first cassette cage (20A) is delivered to a first transfer chamber (25A). Next, the pressure of the first transfer chamber (25A) is reduced via a first pumping valve (24A) to equilibrate the pressure of the first transfer chamber (25A) to a pressure of the processing chamber (˜10 mTorr). Then, the first cassette cage (20A) is introduced through a first gateway (3C) into the loading chamber (1A) via the first stack introduction valve (23A) by the first linear motion feeding mechanism (26A).

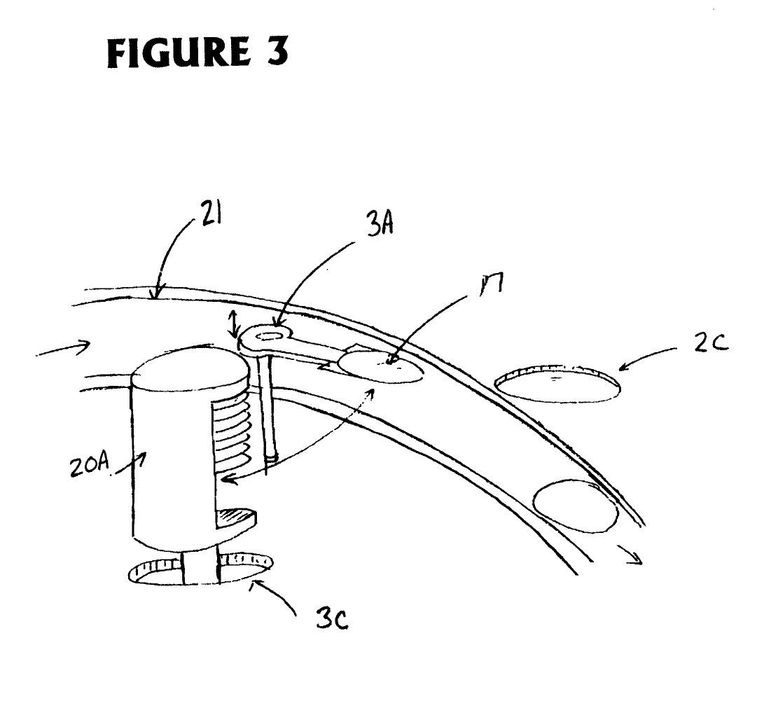

As shown in FIG. 3, the first cassette cage (20A) is introduced into the loading chamber (1A) of the processing chamber via the entry gateway (3C). A robot arm (3A) removes an individual wafer (17) from the first cassette cage (20A) and transfers each individual wafer (17) onto a conveyor track (21).

The conveyor track (21) is a continuous motion, doughnut-shaped track which travels completely within the doughnut-shaped processing chamber. Furthermore, individual wafers placed upon the conveyor track also have a planetary rotational motion to enable uniform coating as the individual wafers travel through the processing chamber.

Simultaneously, as seen in FIG. 2, as wafers of the first cassette cage (20A) are transferred onto the conveyor track (21), a second stack of multiple wafers is transported through the loading portal (4A) and transferred into a second cassette cage (20B) of a stage of a second linear motion feeding mechanism (26B) of the second linear motion introduction chamber (27B). Next, the second cassette cage (20B) is delivered to a second transfer chamber (25B) and a flange of the second linear motion introduction chamber (27B) is mated to a flange of the second transfer chamber (25B) thereby isolating the pressure of the second transfer chamber (25B) from the ambient pressure. Alternatively, after the second cassette cage (20B) is loaded onto a stage of a second linear motion feeding mechanism (26B) of the second linear motion introduction chamber (27B), the flange of the second linear motion introduction chamber (27B) is mated to a flange of the second transfer chamber (25B) and the second cassette cage (20B) is delivered to a second transfer chamber (25B). Alternatively, after the second cassette cage (20B) is loaded onto a stage of a second linear motion feeding mechanism (26B) of the second linear motion introduction chamber (27B), the flange of the second linear motion introduction chamber (27B) is mated to a flange of the second transfer chamber (25B) while simultaneously the second cassette cage (20B) is delivered to a second transfer chamber (25B). Next, the pressure of the second transfer chamber (25B) is reduced via a second pumping valve (24B) to equilibrate the pressure of the second transfer chamber (25B) to a pressure of the processing chamber. Then, the second cassette cage (20B) is introduced through a second gateway (2C) to the loading chamber (1A) via the second stack introduction valve (23B) by the second linear motion feeding mechanism (26B). Once, the second cassette cage (20B) has been successfully introduced into the loading chamber (1A), a robot arm (3A) transfers each individual wafer from the second cassette cage (20B) onto the conveyor track (21).

Simultaneous to the transferring of the individual wafers of the second cassette cage (20B) onto the conveyor track (21), the now-empty first cassette cage (20A) is withdrawn from the loading chamber (1A). The withdrawing process is described by withdrawing the now-empty first cassette cage (20A) from the loading chamber (1A) via the first gateway (3C) and into the first transfer chamber (25A) via the first linear motion feeding mechanism (26A) of the first linear motion introduction chamber (27A). Next, the first stack introduction valve (23A) is closed and the pressure of the first transfer chamber (25A) is equilibrated to ambient pressure via the first pumping valve (24A). The first cassette cage (20A) is withdrawn from the first transfer chamber (25A) into the first linear motion introduction chamber (27A) via the first linear motion feeding mechanism (26A) and the flange of the first linear motion introduction chamber (27A) is disconnected from the flange of the first transfer chamber (25A). Alternatively, the flange of the first transfer chamber (25A) is disconnected from the flange of the first linear motion introduction chamber (27A) and the first cassette cage (20A) is withdrawn from the first transfer chamber (25A) via the first linear motion feeding mechanism (26A). Alternatively, the flange of the first linear motion introduction chamber (27A) is disconnected from the flange of the first transfer chamber (25A) while simultaneously the first cassette cage (20A) is withdrawn from the first transfer chamber (25A) via the first linear motion feeding mechanism (26A).

Once the now-empty first cassette cage (20A) is successfully withdrawn from the first transfer chamber (25A), another stack of multiple wafers is transported through the loading portal (4A), and is transferred into the first cassette cage (20A). This loading and withdrawing process repeats until all necessary stacks of multiple wafers have been loaded into the processing chamber.

By implementing a loading chamber having multiple loading mechanisms, a significant increase in the throughput of the processing system of the present invention is obtained. For example, by using two sets of wafer-loading mechanisms, the processing system of the present invention doubles the throughput of a single-wafer loading mechanism processing system.

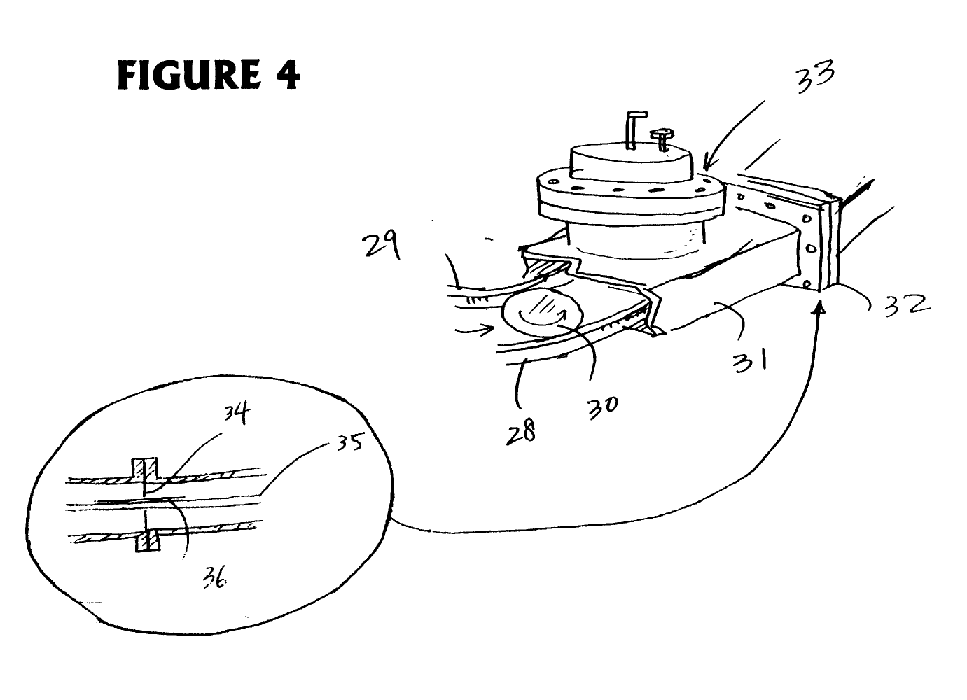

As shown in FIG. 4, an individual wafer (30) travels through the processing chamber via a conveyor track (35) into a deposition stage (33). As the wafer travels between deposition stages, an outer side (28) of the conveyor track (35) remains relatively stationary while an inner side (29) of the conveyor track (35) rotates which moves the wafers radially along the processing chamber, as well as rotates the wafer. These relative movements provide for a more uniform coating of the wafer surface. As can be seen in Fig.4, there are no gate valves between deposition stages. The elimination of gate valves and their associated pumps, control electronics and other miscellaneous parts result in significant reductions in equipment costs and facility maintenance.

As seen in FIG. 4, by providing a processing chamber having multiple deposition stages and a conveyor track continuously moving through each deposition stage, the processing chamber has a minimal cross sectional area such that pumping efficiency of the processing system is maximized. Furthermore, as seen in FIG. 4, there are shield plates (34) placed above and below the conveyor track (35) at flange connections (32) made between each deposition stage (33) and adjoining intermediate chamber portions. These shield plates minimize contamination of wafers (36) between different deposition stages of the processing chamber.

As the individual wafers travel through the processing chamber upon the continuously moving conveyor track, and are individually processed according to desired processing steps and desired throughput, they travel to the unloading chamber (1B) of the processing chamber. Once the individual wafers arrive at the unloading chamber (1B) via the conveyor track, the individual wafers are transferred from the conveyor track via robot arms (2B,3B) into empty cassette cages which are placed onto linear motion withdrawing mechanisms of the unloading chamber.

Like the loading process detailed above, the unloading process is also a continuous process. Once an empty first cassette cage is filled with individual processed wafers in the unloading chamber, the now-full first cassette cage is then withdrawn from the unloading to a transfer chamber. Simultaneous to the withdrawal of the now-full first cassette cage from the unloading chamber, an empty second cassette cage is being filled with individual processed wafers in the unloading chamber. Likewise, once this second cassette cage is filled with individual processed wafers, it is withdrawn from the unloading chamber to a transfer chamber.

When the now-filled cassette cages are withdrawn from the transfer chambers, the stacks of individual processed wafers are removed from the cassette cages of the linear motion feeding mechanism of the unloading chamber and transported through the unloading portal (4B).

When a different kind of layers should be deposited on the wafers, a contamination from the different layers may occur. In such cases, a plurality of processing chamber systems may be required to prevent the contamination. Centralized transfer and loading chambers are shared by each processing chamber. An additional moving conveyor track is provided with each additional processing chamber. In this embodiment, each processing chamber system may be vertically overlapped one another to reduce the space for the whole system. Alternatively, the processing chamber systems may be located to be perpendicular to the ground.

The present invention is not limited to the above specific embodiments, and various modifications can be made. For example, the wafers of the present invention may be any specific type of object wherein processing is required to be performed thereupon. Furthermore, the deposition stages could be substituted partially or completely with other processing tools. Furthermore, the number of deposition stages, or number of other processing tools can be varied to achieve specific throughput requirements. For example, to increase the throughput of the present invention increase the number of deposition stages and/or processing tools. Furthermore, increased throughput of the processing system of the present invention can be achieved by increasing the number of entry and exit gateways as well as the number of corresponding robot arms. Furthermore, the sequence for loading cassette cages can be modified such that at least one cassette cage is present in a transfer chamber when a cassette cage is present in the loading chamber. Likewise, the sequence for unloading cassette cages can be modified such that at least one cassette cage is present in a transfer chamber when a cassette cage is present in the unloading chamber.

As described previously, a multi wafer introduction/single wafer conveyor mode processing system and method of processing wafers using the same in the present invention provides a maximum throughput limited only by available maximum speed of the robot arm within the system unlike the conventional methods and systems. Thus, with a development of technologies in the transporting speed of the wafers, the present invention provides a system and method of processing wafers having much increased throughput over the conventional systems and methods. Accordingly, the number of deposition tools within a conveyor ring to maximize the throughput is determined by the maximum available transport speed of the robot arm and the deposition rate of the desired material layer.

It will be apparent to those skilled in the art that various modifications and variations can be made without departing from the scope or spirit of the invention. Thus, it is intended that the present invention covers the modifications and variations of this invention provided they come within the scope of the appended claims and their equivalents.

What is claimed is:

1. A method of processing a stack of multiple wafers to a processing chamber system, the method comprising the steps of:
loading a first stack of multiple wafers onto a stage;
delivering the first stack to a first transfer chamber,
wherein a pressure of the first transfer chamber is equilibrated with a pressure of the processing chamber system;
introducing the first stack to a loading chamber of the
processing chamber system; and
transferring each individual wafer of the first stack to a circular conveyor track, wherein a second stack including multiple wafers is introduced to a second transfer chamber simultaneously as the transferring step is performed.

2. The method of claim 1 wherein the introducing step comprises elevating the stage.

3. The method of claim 1, wherein the transferring step is carried out by a robot arm.

4. The method claims 1, wherein the circular conveyor track has a continuous motion along a shape of the processing chamber system.

5. The method of claim 4, wherein the shape of the processing chamber system is doughnut-shaped.

6. The method of claim 4, wherein the each individual wafer after the transferring step comprises a planetary rotational motion.

7. The method of claim 6, wherein the processing chamber system comprises plural deposition stages, such that no vacuum-tight valves are located between the plural deposition stages.

8. The method of claim 7, further comprising a shield plate disposed between the plural deposition stages.

9. The method of claim 7, wherein a maximum throughput of the processing chamber system is limited only by an available maximum transferring speed of the wafers to the circular conveyor track.

10. A wafer processing system comprising:
an introduction chamber receiving at least one stack of multiple wafers;
a transfer chamber coupled to the introduction chamber, transferring the stack of multiple wafers;
a loading chamber coupled to the transfer chamber;
at least one processing chamber system coupled to the loading chamber, receiving the wafers from the loading chamber; and
at least one circular, continuously moving conveyor track disposed within the processing chamber system.

11. The wafer processing system of claim 10, wherein the processing chamber system is doughnut-shaped.

12. The wafer processing system of claim 10, wherein the processing chamber system comprises plural deposition stages, such that no vacuum-tight valves are located between the plural deposition stages.

13. The wafer processing system of claim 10, further comprising a shield plate disposed between the plural deposition stages.

14. The wafer processing system of claim 12, wherein a maximum throughput of the wafer processing system is limited by only an available maximum transferring speed of the wafers to the circular conveyor track.

15. The wafer processing system of claim 10, wherein the processing chamber system and the conveyor track comprise a plurality of processing chamber systems and a plurality of conveyor tracks, wherein each processing chamber system shares the same transfer and loading chambers.

16. The wafer processing system of claim 15, wherein the plurality of the processing chamber systems are located with substantially the same vertical level with respect to the ground.

17. The wafer processing system of claim 15, where each processing chamber system is substantially vertically overlapped one another with respect to the ground.

18. The wafer processing system of claim 15, wherein each processing chamber system is substantially perpendicular with respect to the ground.
